(19) United States
(12) Patent Application Publication
(10) Pub. No.: US 2011/0154707 A1
(43) Pub. Date: Jun. 30, 2011

(54) RECOIL REDUCER STOCK

(76) Inventor: John F. Noonan, Doraville, GA (US)

(21) Appl. No.: 12/897,321

(22) Filed: Oct. 4, 2010

Related U.S. Application Data
(60) Provisional application No. 61/248,006, filed on Oct. 2, 2009.

(51) Int. Cl. F41C 23/06; F41C 23/22; B29C 39/02

(52) U.S. Cl. 42/1.06; 42/71.01; 264/238; 42/74

(57) ABSTRACT

A rifle stock having one or more cavities for receiving recoil reducing mechanisms is provided.

### CROSS-REFERENCE TO RELATED APPLICATIONS

This application claims the benefit of U.S. Provisional Application Ser. No. 61/248,006, which was filed on Oct. 2, 2009 and is incorporated herein by reference in its entirety.

### FIELD

The present invention relates to a recoil reducer stock.

### BACKGROUND

Recoil in firearms is a common and well-known problem in the firearms industry. Recoil affects shooting accuracy (e.g., due to the flinch associated with anticipating the recoil) and causes injury.

AR-style rifles (e.g., AR15/M16/M4 and AR10) comprise an A2 stock (hereinafter referred to as “AR-A2 stock”). In some embodiments, the AR-A2 stock is filled with foam except for a hollow cavity (i.e., storage compartment) used for storing cleaning supplies. To reduce recoil in an AR-style rifle, a solid lead weight (hereinafter referred to as “lead wedge”) is placed in the AR-A2 stock storage compartment. However, lead wedges generally are not a good fit and eventually dislodge and damage the stock. Lead wedges also are heavy making it difficult to carry the rifle. Recoil pads also are used to reduce recoil. However, recoil pads are less effective in reducing recoil and do not allow for the use of the storage compartment in the AR-A2 stock. Other recoil devices are expensive and require custom fitting to each gun stock and do not work with the AR-A2 stock. These other recoil devices are used on custom built rifles for target shooting and hunting.

Accordingly, there is a need for a recoil reducing system for AR-style rifles that may not damage the AR-A2 stock, may be relatively light weight, and may be inexpensive.

### BRIEF DESCRIPTION OF THE DRAWINGS

FIG. 1 illustrates a prior art AR-A2 stock.

FIG. 2 illustrates an AR-A2 recoil reducer stock according to an exemplary embodiment of the present invention.

FIG. 3 illustrates an exemplar shape of the filler in the AR-A2 recoil reducer stock of FIG. 2.

FIG. 4 illustrates exemplary recoil reducers that maybe inserted into the cavities of the AR-A2 recoil reducer stock of FIG. 2.

FIG. 5 illustrates an AR-A2 recoil reducer stock according to another exemplary embodiment of the present invention.

### DETAILED DESCRIPTION

Exemplary embodiments of the present invention are directed to recoil reducing systems for AR-style rifles (e.g., AR15/M16/M4 and AR10).

Various embodiments of the present inventions now will be described with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements.

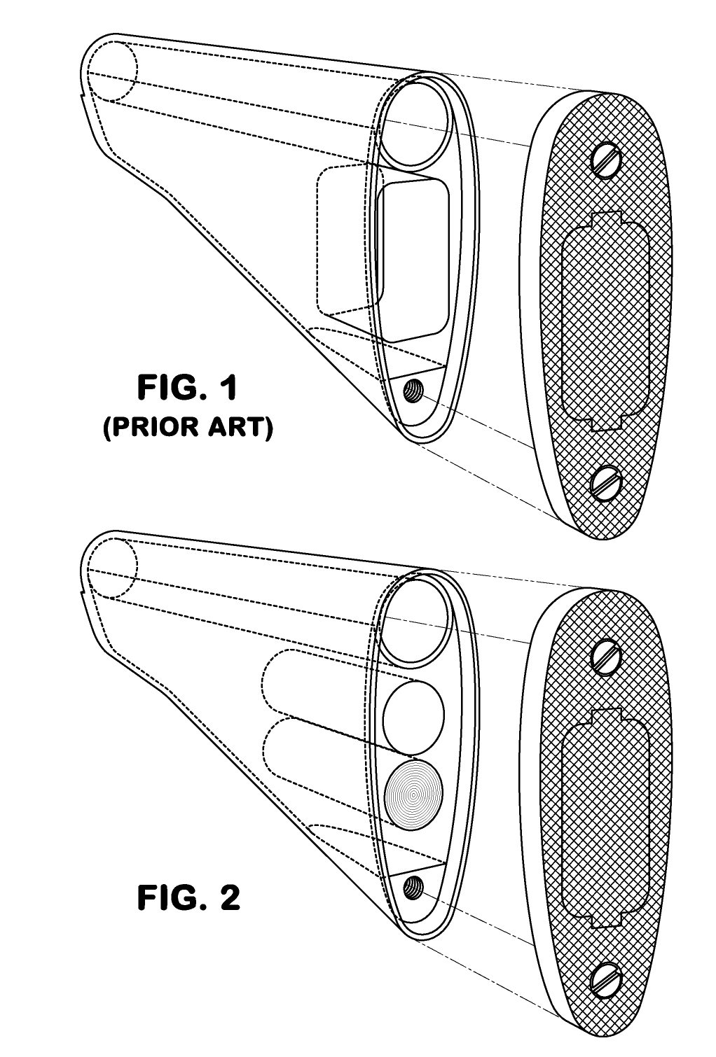

FIG. 1 illustrates a standard AR-A2 stock 100. As shown in FIG. 1, a standard AR-A2 stock may be filled with foam 105 except for a hollow cavity 110 (i.e., storage compartment) used for storing cleaning products. To reduce recoil in AR-style rifles, in an exemplary embodiment of the present invention, the standard AR-A2 stock is modified to create an AR-A2 recoil reducer stock. FIG. 2 illustrates an AR-A2 recoil reducer stock 200 according to an exemplary embodiment of the present invention.

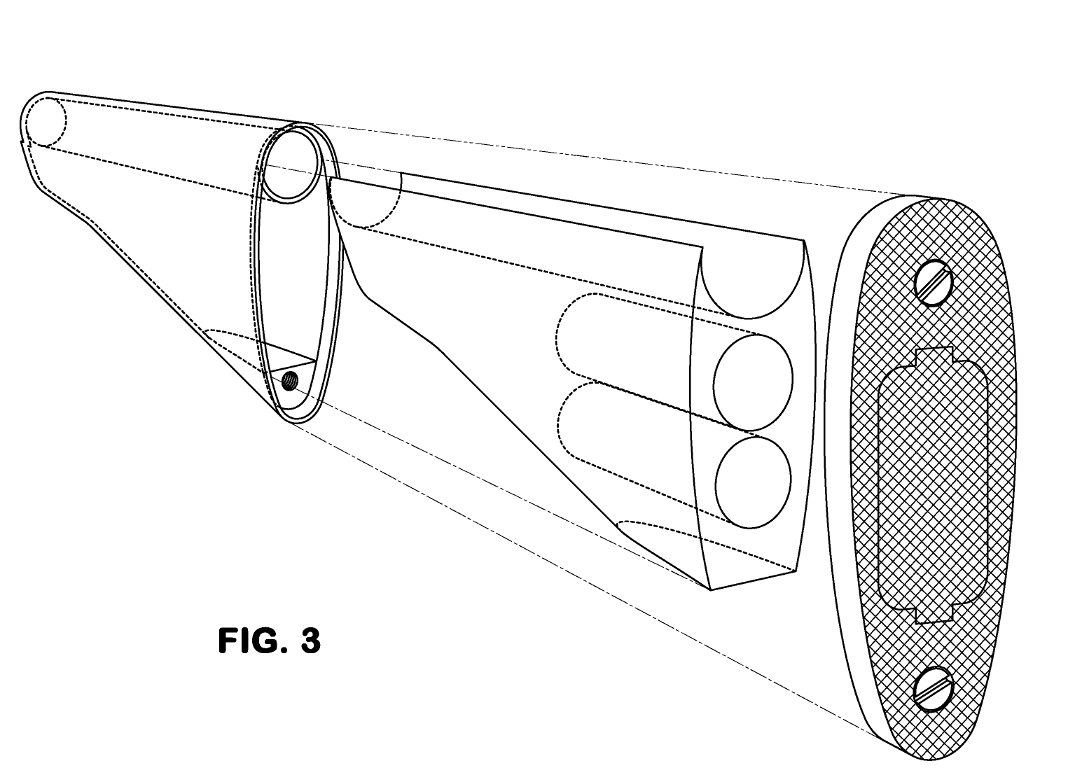

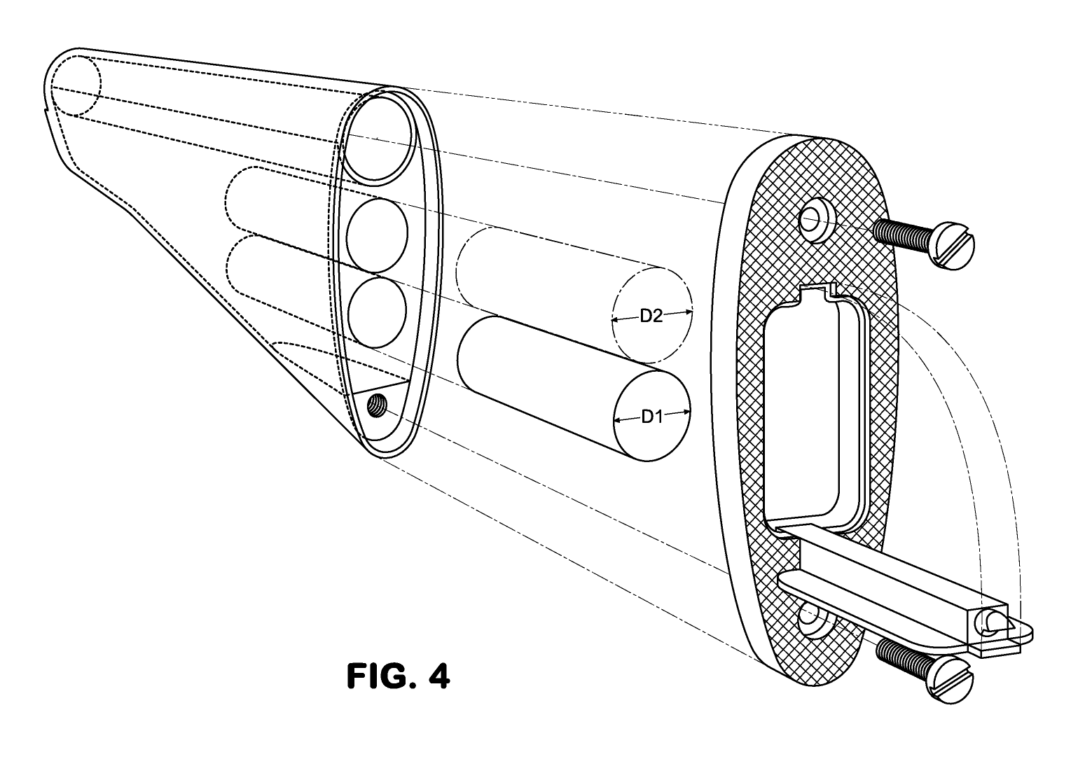

To reduce recoil in AR-style rifles, in an exemplary embodiment of the present invention, first, the cavity of the standard AR-A2 stock is enlarged by removing some or all of the foam filler 105 or other inserts (e.g., a plastic insert) in the AR-A2 stock. Then, in an exemplary embodiment, a fiberglass resin is poured in the AR-A2 stock to produce the filler 205 and a mold is inserted to produce two (2) cavities 210 to, in one embodiment, receive mechanical recoil reducers such as those used in shotguns. In an alternative embodiment, a 50/50 blend of polyester resin and microspheres are used as filler. A person of ordinary skill in the art could determine the amount of fiberglass resin and dimensions of the mold necessary to produce the desired cavities. FIG. 3 illustrates an exemplar shape of the resulting filler 305 in the stock after the above process. The filler 305 is shown as being removed from the stock for illustration purposes. FIG. 4 illustrates exemplary recoil reducers 405 that maybe inserted into the cavities 210.

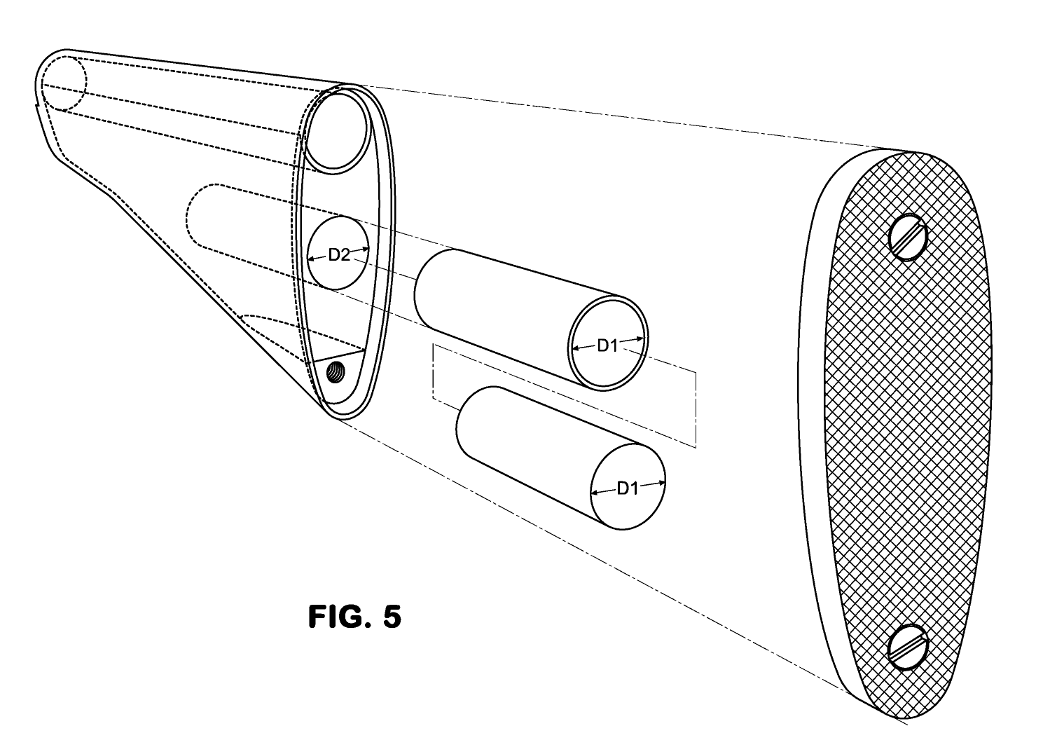

In one embodiment, the cavities 210 may be ⅞″ in diameter or larger and may be 3″ to 5″ in length to receive standard mechanical recoil reducers. In one embodiment, one cavity may be of a different size and/or shape and/or receive a different recoil reducer mechanism than another cavity in the AR-A2 recoil reducer stock. In one embodiment, the cavities 210 of the AR-A2 recoil reducer stock may be configured to receive any other recoil reducer mechanism such as round lead bars or lead washers or any other recoil reducer mechanism made of any material. For example, in one embodiment a weight followed by a spring may be inserted directly into the cavities 210. One or more cavities may be formed to each receive a recoil reducer. The cavity or cavities may be any size or any shape to receive any recoil reducer mechanism. As shown in FIG. 5, one cavity 510 is formed to receive a recoil reducer 515. In the embodiment of FIG. 5, the cavity 510 has a diameter of D2 and the recoil reducer 515 has a smaller diameter of D1. A sleeve 520 may be used to fit the recoil reducer 515 in the cavity 510. That is, the recoil reducer 515 may be inserted into the sleeve 520 and the sleeve 520 and recoil reducer 515 are inserted into the cavity 510.

In one embodiment, one or more cavities of the AR-A2 recoil reducer stock may be configured to receive any other object such as spare batteries for scopes, sights, or lasers.

In an alternate exemplary embodiment of the present invention, an AR-A2 recoil reducer stock is created by, after enlarging the cavity of the standard AR-A2 stock, pouring a portion of the total amount of fiberglass resin to be used (e.g., ½ the total amount of fiberglass resin) into the AR-A2 stock, inserting a mold, and then allowing the fiberglass resin to harden (e.g., 15 minutes). The remaining fiberglass resin is then poured into the AR-A2 stock.

In another exemplary embodiment of the present invention, the enlarging step may be skipped if, for example, the existing cavity of the AR-A2 stock is large enough to receive the fiberglass resin and mold. In another exemplary embodiment of the present invention, the AR-A2 stock is filled with epoxy or any other casting material. In yet another exemplary embodiment of the present invention, the AR-A2 recoil reducer stock is formed by injection molding. Furthermore, the embodiments of the invention may be applied to other composite stocks.

Many modifications and other embodiments of the invention will come to mind to one skilled in the art to which this invention pertains having the benefit of the teachings presented in the forgoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Reference throughout this specification to “an embodiment,” “one embodiment”, or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Furthermore, the described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

What is claimed:

1. An apparatus comprising:
a rifle stock having one or more cavities wherein each cavity is configured to receive a recoil reducer.

2. The apparatus of claim 1 wherein the one or more cavities are at least ⅞″ in diameter and at least 3″ in length.

3. The apparatus of claim 1 wherein the rifle stock is an AR-style rifle stock.

4. The apparatus of claim 1 wherein the rifle stock has one cavity.

5. The apparatus of claim 1 wherein the rifle stock has at least two cavities.

6. An apparatus comprising:
a rifle stock having at least one cavity; and
at least one recoil reducer mechanism inserted in the at least one cavity.

7. The apparatus of claim 6 wherein the at least one recoil reducer mechanism is at least one separate weight and at least one separate spring.

8. A method of manufacturing a recoil reducer stock comprising:
forming one or more cavities in a stock to each receive a recoil reducer.

9. The method of claim 8 wherein the stock is a standard stock and the forming step comprises pouring a predetermined amount of casting material in the standard stock and inserting a mold to create the one or more cavities.

10. The method of claim 8 wherein the forming step is performed during an injection molding process.
